(19) United States
(12) Patent Application Publication
(10) Pub. No.: US 2007/0192612 A1
(43) Pub. Date: Aug. 16, 2007

(54) Image data processing apparatus, image data processing method, program and recording medium

(75) Inventor: Takeo Morohashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/441,221

(22) Filed: May 26, 2006

(30) Foreign Application Priority Data
Feb. 8, 2006 (JP) 2006-030965

(51) Int. Cl. H04L 9/00

(52) U.S. Cl. 713/176

(57) ABSTRACT

Disclosed is an-image data processing apparatus including: an authentication section which authenticates a user who uses at least a part of the image data processing apparatus, based on inputted authentication information and previously set authentication information; and a controlling section which attaches the previously set authentication information as information to authenticate the user of the image data with an image data to be stored in an external storage.

### CROSS-REFERENCE TO RELATED APPLICATION

The present U.S. patent application claims a priority under the Paris Convention of Japanese patent application No. 2006-30965 filed on Feb. 8, 2006, and shall be a basis of correction of an incorrect translation.

### BACKGROUND

1. Field of the Invention

The present invention relates to an image data processing apparatus, an image data processing method, a program and a recording medium, and especially relates to an image data processing apparatus, an image data processing method, a program and a recording medium, those of which comprise user authentication function.

2. Description of Related Art

In recent years, a computer and peripherals thereof are networked with the development in information communication technology. For example, it is general that an image reading apparatus such as a printer and facsimile and a copier which integrates a plurality of these functions are connected through network so as to be shared with a plurality of computers (for example, consumer PCs (personal computer), workstations or various server computers). Image data obtained in a reading apparatus or the like is stored in a storage (for example, a recording medium such as a hard disk installed in the reading apparatus, PC, file server or the like) which is generally accessible from any PC. Thus, there is a problem of security in information management.

In order to ensure the security in information management, a reading apparatus or the like is often provided with an authentication function in which ID information of a user who is permitted to use the apparatus is previously registered, it is required to input a password before using the apparatus and it is judged whether or not to permit to use the apparatus based on the password and registered ID information. In an authentication function which only judges whether or not to permit to use the apparatus, image data and password are managed separately. Thus, it is problematic that the security is not retained when the image data is copied or moved to the other PC, file sever or the like. That is, when the image data or the like moved to the other PC or file server is accessed from the other equipment connected to the network, no security works against the access to the image data. In this regard, JP 2001-350726A discloses an image reading apparatus in which it is required to input ID information in reading an original image with a scanner or the like, the obtained image data is encoded, the ID information is attached to a decoding program which decodes the encoded image data, the decoding program is transmitted and stored to a storage of a PC or file server present on the network. When the image data is decoded, it is required to input the ID information again, and the image data is decoded (i.e. the file is expanded to be in a condition that a content of the image data can be recognized) only when the input ID information matches with the ID information attached with the decoding program.

However, there is a problem in the disclosure of JP 2001-350726A that the operation is complicated and takes some troubles, because a user is required to input the ID information every time data is transmitted and stored to the storage of a PC, file server or the like present on the network. In particular, now that information technology has been developed, for example, it has become normal to move image data read in an image reading apparatus to a PC or file server and the number of such works is enormous. When the ID information is input and set to every transmittance of image data as disclosed in JP 2001-350726A, it takes more troubles and time. Thus, it is problematic that there is difficulty in achieving smooth utilization of information.

### SUMMARY

The present invention was made in order to solve the above problem. It is one of the objects of the invention to facilitate a transmittance of image data without complicated setting required in every transmittance while a security of information management is ensured, when the image data is transmitted to the other storing apparatus present on the network.

(1) According to one embodiment reflecting a first aspect of the invention, an image data processing apparatus comprises: an authentication section which authenticates a user who uses at least a part of the image data processing apparatus, based on inputted authentication information and previously set authentication information; and a controlling section which attaches the previously set authentication information as information to authenticate the user of the image data with an image data to be stored in an external storage.

(2) In the abovementioned embodiment (1), the image data processing apparatus preferably further comprises: an authentication control program forming section which forms an authentication control program to authenticate a user when the image data is used, based on the previously set authentication information. In this case, the controlling section attaches the authentication control program with the image data.

(3) In the abovementioned embodiment (1), the image data processing apparatus preferably further comprises: a storage section which stores the image data. In this case, the previously set authentication information is preferably authentication information to use at least a part of the storage section.

(4) In the abovementioned embodiment (3), when data size of the image data is more than storage capacity of the storage section, the authentication information is preferably attached with the image data and the image data is stored in the external storage.

(4) In the abovementioned embodiment (3), the storage section preferably comprises a plurality of data storage units each having predetermined storage capacity, and the image data is preferably stored in one of the data storage units.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein;

FIG. 1 is a block diagram showing internal constitution of an MFP in the preferred embodiment of the invention,

FIG. 2 is a schematic view showing communication environment connected to the MFP of FIG. 1 through a network,

FIG. 3 is a schematic view showing one example of user authentication information previously set in the MFP of FIG. 1,

FIG. 4 is a schematic view showing one example of a box authentication information previously set in the MFP of FIG. 1,

FIG. 5 is a schematic view showing an example of a user authentication screen displayed on the operation display of the MFP of FIG. 1,

FIG. 6 is a schematic view showing an example of a scanning setting screen displayed on the operation display of the MFP of FIG. 1,

FIG. 7 is a schematic view showing an example of a destination setting screen displayed on the operation display of the MFP of FIG. 1,

FIG. 8 is a schematic view showing an example of a process in the MFP of FIG. 1,

FIG. 9 is a schematic view showing an example of a process in the MFP of FIG. 1,

FIG. 10 is a schematic view showing an example of a process in the MFP of FIG. 1,

FIG. 11 is a block diagram showing a schematic constitution of the client PC of FIG. 2,

FIG. 12 is a flowchart showing an example of a user authentication process performed in the client PC of FIG. 11 in cooperation with the “authentication control program” formed in the MFP of FIG. 1,

FIG. 13 is a schematic view showing an example of a user authentication screen displayed on a monitor of the client PC of FIG. 11, and

FIG. 14 is a flowchart showing an example of a user authentication process performed in the client PC of FIG. 11 in cooperation with the “authentication control program” formed in the MFP 1 of FIG. 1.

### DETAILED DESCRIPTION OF THE PREFERRED EMBODIMENT

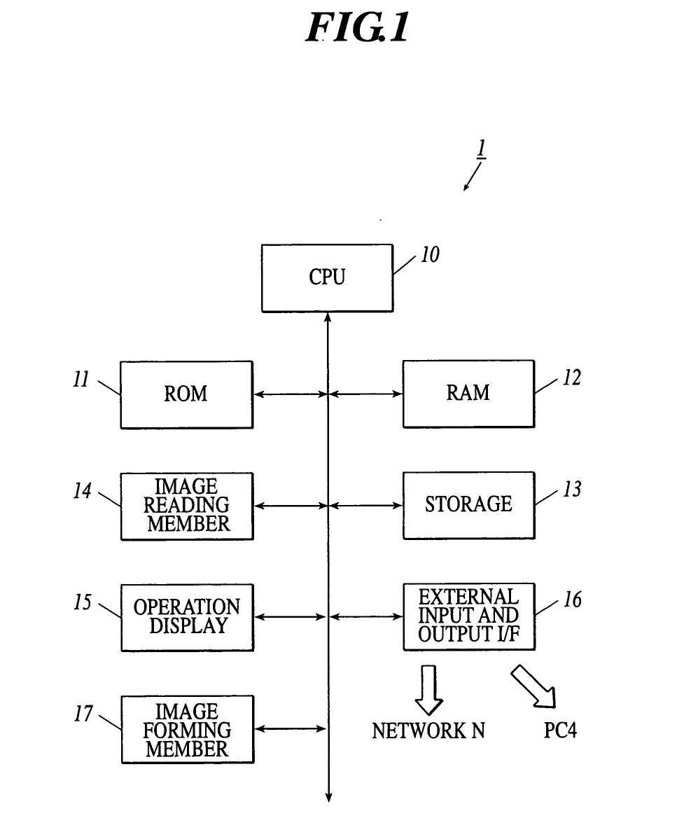

The embodiment of the present invention is described with reference to the drawings. FIG. 1 is a block diagram showing a schematic constitution of an MFP (multi function peripheral) 1 to which the present invention is applied.

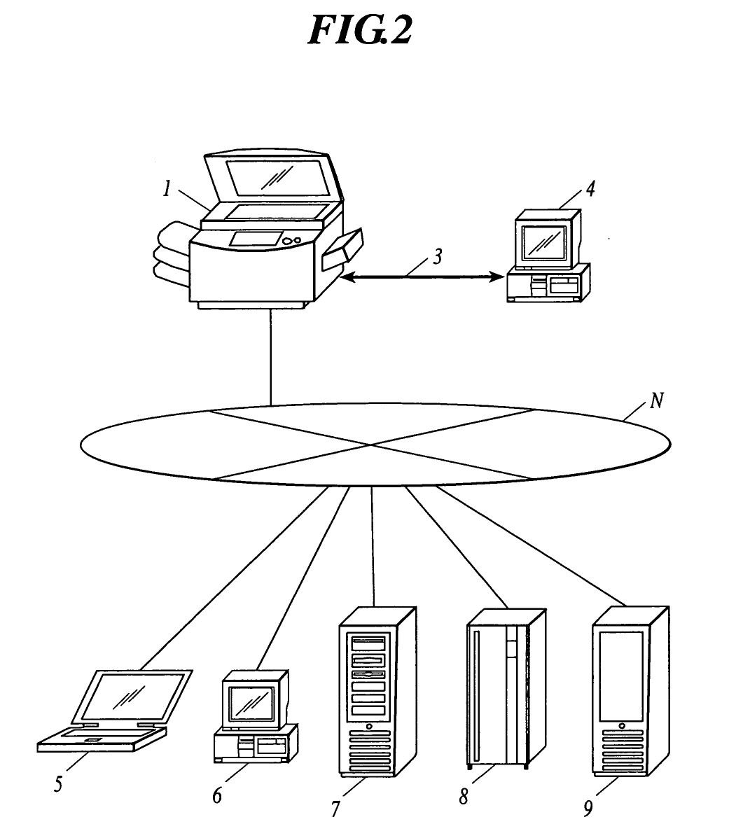

The MFP 1 comprises a CPU (central processing unit) 10, a ROM (read only memory) 11, a RAM (random access memory) 12, a storage 13, an image reading member 14, an operation display 15 and an external input and output I/F (inter/face) 16, those of which are connected electrically and electronically with each other through a main bus 18. As shown in FIG. 2, it is also possible that the MFP 1 connects to a PC (personal computer) 4 through a USB cable 3 to be communicate with each other and the PC 4 takes a role of a control system. In the present embodiment, the PC 4 further can accept operation input, and a read original image data can be transmitted to client PCs 5 and 6, an e-mail server 7, FTP (file transfer protocol) server 8 and a SMB (server message block) server 9 through the network N.

In FIG. 1, the CPU 10 is a control system to control the MFP 1 wholly, which reads out an operation program and application program previously stored in the ROM 11 or storage 13, expands them to the RAM 12 of a work area and performs various processing. Specifically, the CPU 10 reads out an “authentication control program forming program” which is an operation program or application program previously stored in the ROM 11 or storage 13, and performs an “authentication control program forming process” to forms an “authentication control program” which requires a user to input ID (identification) information when file data of original image data recorded in a storage installed in the client PCs 5 and 6 or the like is opened on the client PCs 5 and 6 or the like, and automatically judges whether or not the user is a rightful user of the file data. The CPU 10 also attaches this “authentication control program” with the original image data and transmits it to the client PCs 5 and 6, e-mail server 7, FTP server 8 or SMB server 9.

The “authentication control program” is, for example, described in a script language and is to cause a supplemental function to an application program of the client. In the present embodiment, the “authentication control program” is described in JAVASCRIPT®.

Back to FIG. 1, the ROM 11 is a read only memory composed of a non-volatile semiconductor element, and previously stores an operation program, various application programs and the like. The RAM 12 is a random readable/writable memory composed of a volatile semiconductor element, and functions as a work area.

The memory 13 comprises a hard disk, flash memory of a non-volatile memory or the like, and previously stores an application program such as the “authentication control program forming program”, and also stores (registers) authentication information which represents a usage permission of the original image data read in the image reading member 14 and of the MFP 1. When the MFP 1 is used or various functions thereof are executed, it is judged whether or not the usage is permitted based on this authentication information and the after-mentioned authentication information input through the operation display.

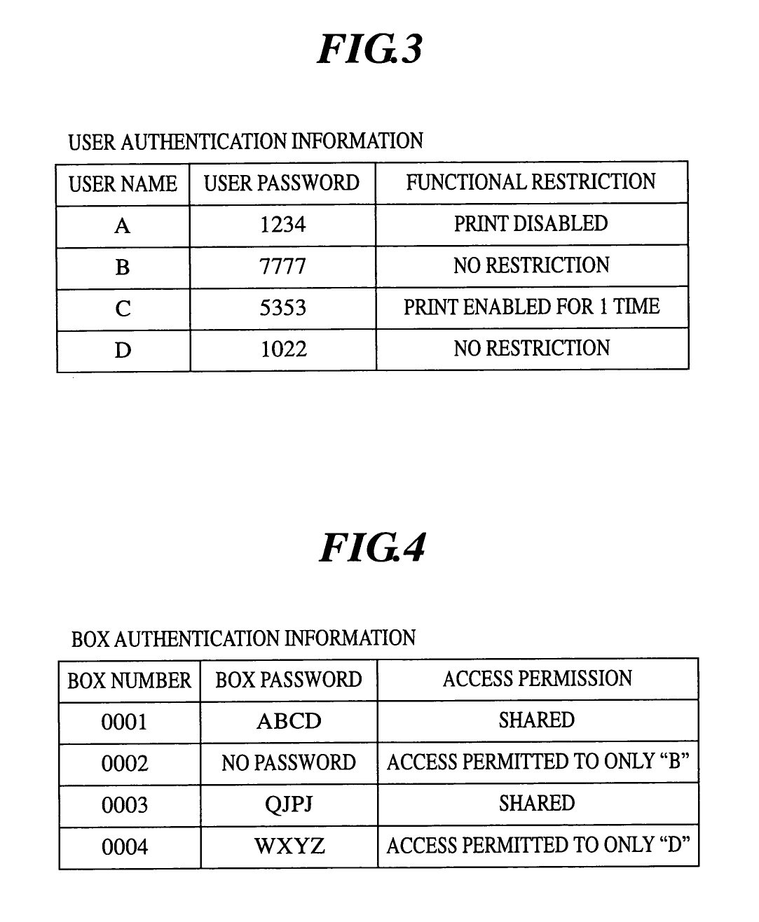

FIG. 3 schematically shows an example of the authentication information registered in the storage 13. A user name, user password, and list of functional restriction are registered as authentication items. The user name is a name of a user who is permitted to use the MFP 1. In FIG. 3, it is shown that user names of “A”, “B”, “C” and “D” are registered. As for the user password, different user password is set to each of the users. As for the functional restriction, available functions among various functions of the MFP 1 are registered with respect to the user. For example, the user name “A” is registered in which the user password is “1234” and a printing function of the MFP 1 cannot be used.

Further, the storage 13 comprises a plurality of storage areas (hereinafter referred to as “boxes”) to store an image data, to each of which a predetermined storage capacity is distributed. Box sharing and access permission to a specific user are set to each of the boxes. The image data read in the image reading member 14 can be utilized in various processing in the MFP 1, such as storing it to the box, moving (sending) it to the client PC 5 or 6, outputting it to the image forming member 17 to print out it, and the like.

Further, the MFP 1 has a box authentication function to utilize the image data stored in the box. When the image data stored in the box is used, it is judged whether or not the usage of the image data is permitted based on the previously registered box authentication information and a box number and box password inputted through the operation display 15, so that security of the image data in storing and managing it is ensured.

The box authentication information is registered when the box to store the image data is set. The setting items comprises box number, box password and access permission or the like as the setting items, and they are stored in the storage 13 as the box authentication information.

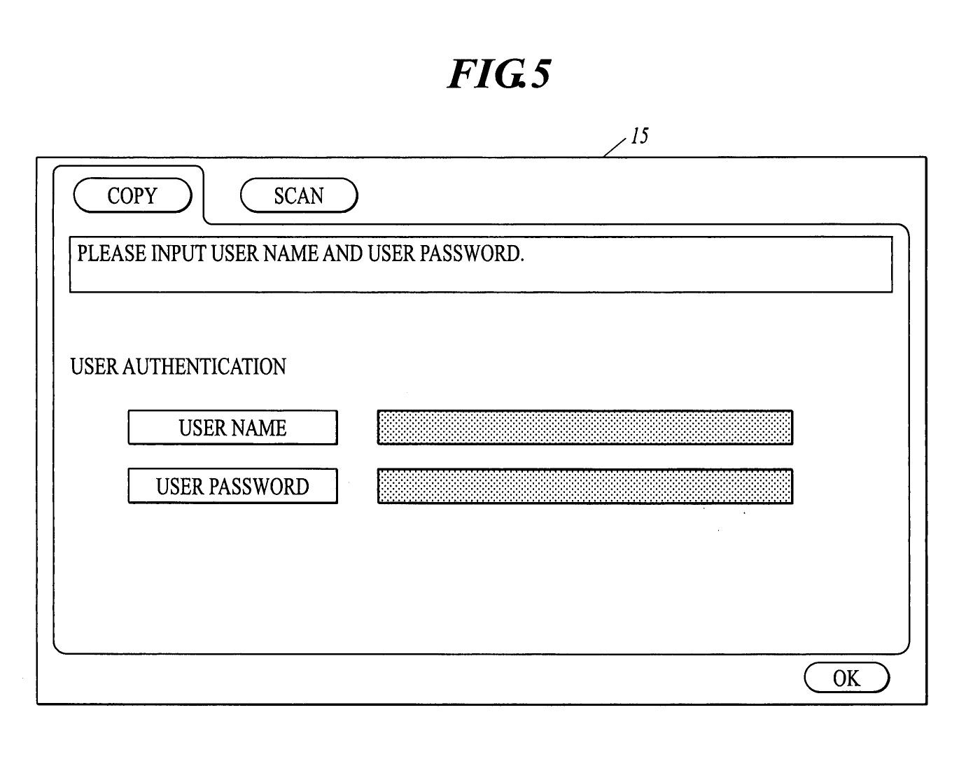

FIG. 4 shows an example of the box authentication information. The box numbers are set at “0001”, “0002”, “0003” and “0004”, and the box password are set at “ABCD”, “no password”, “QJPJ” and “WXYZ” respectively. The box password of “no password” represents that the box password is not registered. The items of access permission are set at “print disabled”, “no restriction”, “print enabled for 1 time” or “no restriction” respectively. “Print disabled” represents that it is prohibited to print an image data stored in the box of box number “0001”, and “print enabled for 1 time” represents that an image data stored in the box of box number “0003” is capable of being printed for 1 time in a certain period. Further, the access permission of “no restriction” represents that no functional limitation is registered.

In FIG. 1, the image reading member 14 comprises a scanner unit known in the art. The scanner unit emits light to an original to be read, detects reflected light with a CCD (charge coupled device) image sensor or CMOS (complementary metal-oxide semiconductor) image sensor, converts the detected analogue electrical signal to a digital signal with an A/D converter which is not shown, and outputs it to the CPU 10. The scanner unit can employ various types such as a reducing optical system using a lens system to concentrate the reflected light or a contact optical system using a rod lens array.

The external output and input I/F member 16 controls communication with the PC 4 through the USB cable 2 (reception of an operation signal of the MFP 1 and transmission of the read image data or the like), and is connected to a network N such as LAN (local area network), MAN (metropolitan area network), WAN (wide area network) and Internet through NIC (network inter/face card) and controls external communication with the client PCs 5 and 6, e-mail server 7, FTP server 8 and SMB server 9 (reception of an operation signal of the MFP 1 and transmittance of of the read image data or the like).

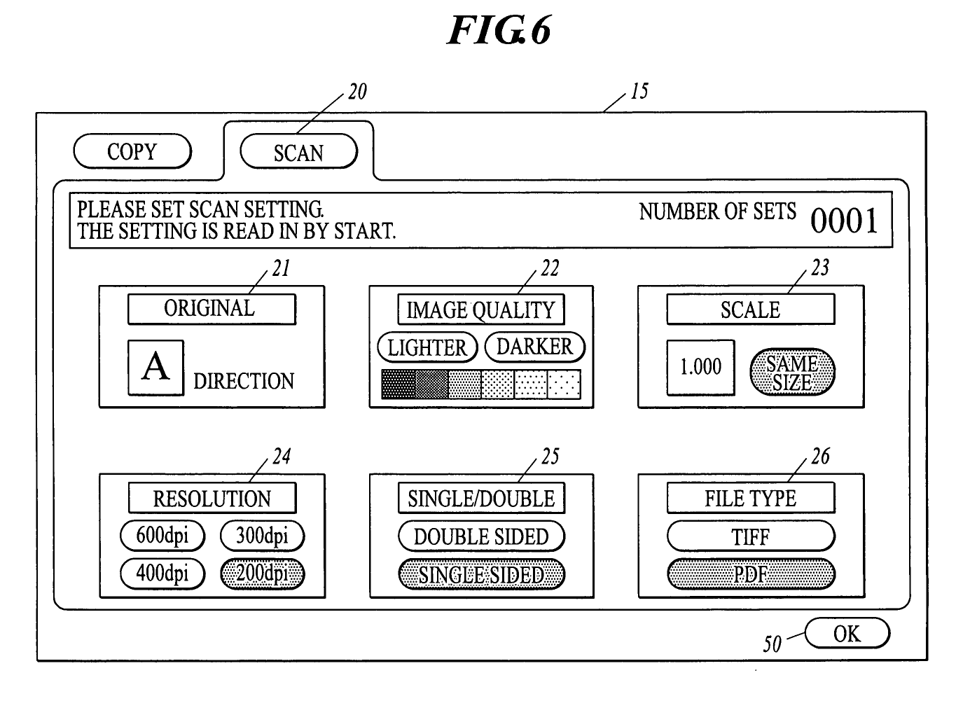

The operation display 15 is a display monitor composed of a LCD (liquid crystal display) or the like, and a display member to display various information of the MFP 1 (setting items or procedure of a process). A display screen of the operation display 15 comprises a touch panel. When an original is read with the image reading member 14, it is displayed as shown in FIG. 6. It displays a scanning setting screen tab 20, original setting button 21 to set mounted direction of an original, image quality setting button 22 to set density of the read image data, magnification setting button 23 to set magnification at reading, resolution setting button 24 to set resolution at reading, reading face setting button 25 to select reading single/double side(s), file type setting button 26 to set file type of the read image data and an OK button 50 to confirm the setting, so that a user can input these various setting or the like.

The image forming member 17 comprises an image forming unit known in the art to form various images by electrophotography or the like, but is not limited thereto and can employ various image forming system such as ink jetting system.

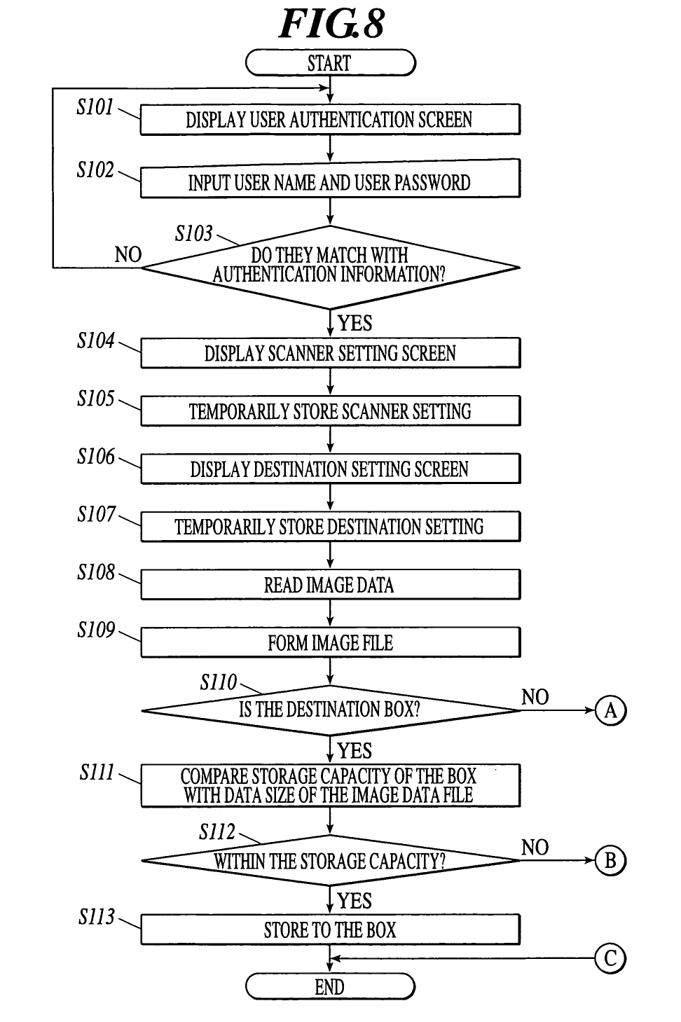

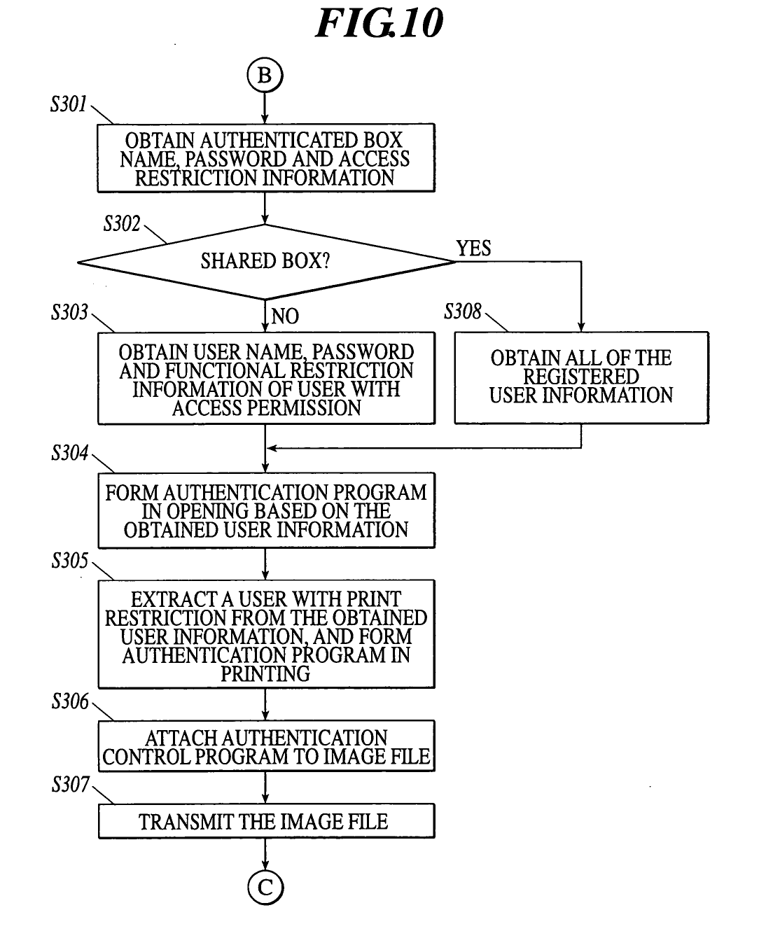

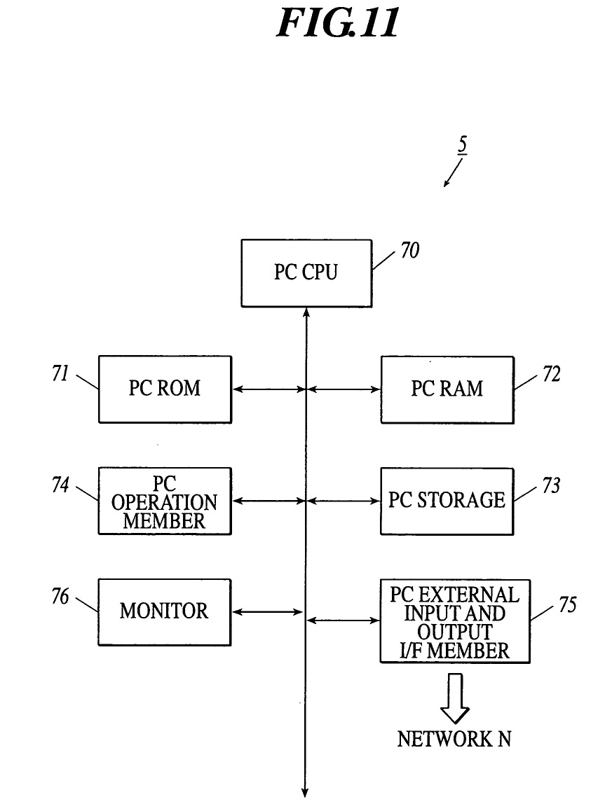

Next, procedure of the “authentication control program forming process” executed in the MFP 1 is described with reference to the flowcharts shown in FIGS. 8 to 10. In the following description, the authentication items shown in FIG. 3 is registered as the authentication information and the authentication items shown in FIG. 4 is registered as the box authentication information in the storage 13 of the MFP 1.

In step S101, the CPU 10 displays on the operation display 15 the user authentication screen to require an input of user name and user password. Start and stop of a user authentication mode to perform the user authentication process can be set on the MFP 1. When the user authentication mode is in a halt condition, the CPU 10 starts the process from step S108 without displaying the user authentication screen on the operation display 15.

In step S102, the CPU 10 receives an input signal of a user name and user password which is inputted by user's operation.

In step S103, the CPU 10 reads the user authentication information previously stored in the storage 13 (see FIG. 3), and judges whether or not the user name and user password received in step S102 match with this authentication information. When the user name and user password received in step S102 do not match with the authentication information, the process shifts to step S101 and the user authentication screen is displayed (step S103: No). When the user name and user password received in step S102 match with the authentication information, usage restriction is canceled and the process shifts to step S104.

In step S104, the CPU 10 displays a scanner setting screen as shown in FIG. 6 on the operation display 15. In the present embodiment, the scanning setting is set as original of longitudinal direction, image quality of default setting, resolution of 200 dpi, reading face of single side, and file type of the read image data of PDF.

In step S105, the CPU 10 receives the scanning setting inputted by a user operating the OK button 50, and temporary stores the setting in the RAM 12.

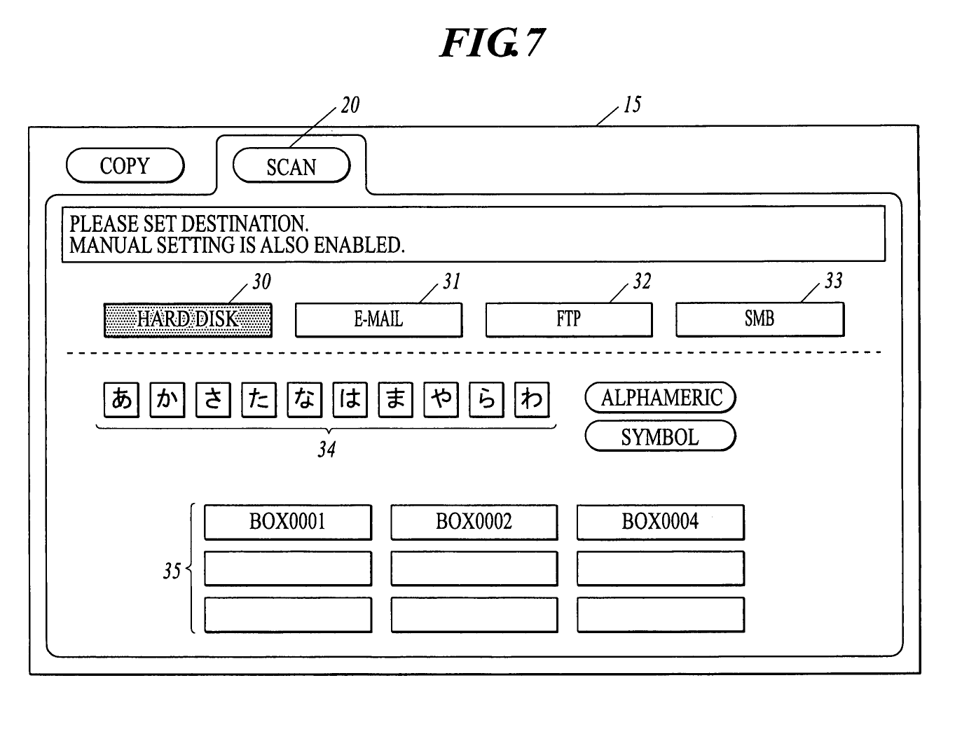

In step S106, the CPU 10 displays an output destination setting screen to set an output destination of the image data to be read in the image reading member 14, as shown in FIG. 7. A user sets a destination to save the image data by pushing any of a hard disk button 30, e-mail button 31, FTP button 32 and SMB button 33. When it is presumed that the hard disk button 30 is pushed, the CPU 10 displays on a box display area 35 the box number to which a particular user is permitted to access based on the box authentication information (see FIG. 4). For example, when the user is “A”, the box numbers of “0001”, “0002” and “0004” are displayed on the box display area 35. A user can designate an output destination of the image data by pushing a button of desired box to which the image data is stored among the buttons which represents respective boxes shown on the box display area 35. Further, the box number can be changed to any optional number or name by operating character input keys 34.

When a password is set to the box password of the box authentication information, the CPU 10 displays a screen to require input of the password (not shown) on the operation display 15.

In step S106, when a user operates the e-mail button 31, FTP button 32 or SMB button 33, the CPU 10 transmits the image data file can be transmitted to an terminal or the like having an address based on each transmission protocol (for example, the client PCs 5 and 6).

In step S107, the CPU 10 temporary stores in the RAM 12 the setting of destination of the image data file inputted by a user in step S106.

In step S108, the CPU 10 receives a reading direction signal of an original image transmitted by a user's operation, so as to read the original image mounted on an original stage of the image reading member 14.

In step S109, the CPU 10 forms file data of predetermined file format (PDF format in the present embodiment) from the image data read in step S108, based on scanning setting information temporary stored in the RAM 12 in step S105.

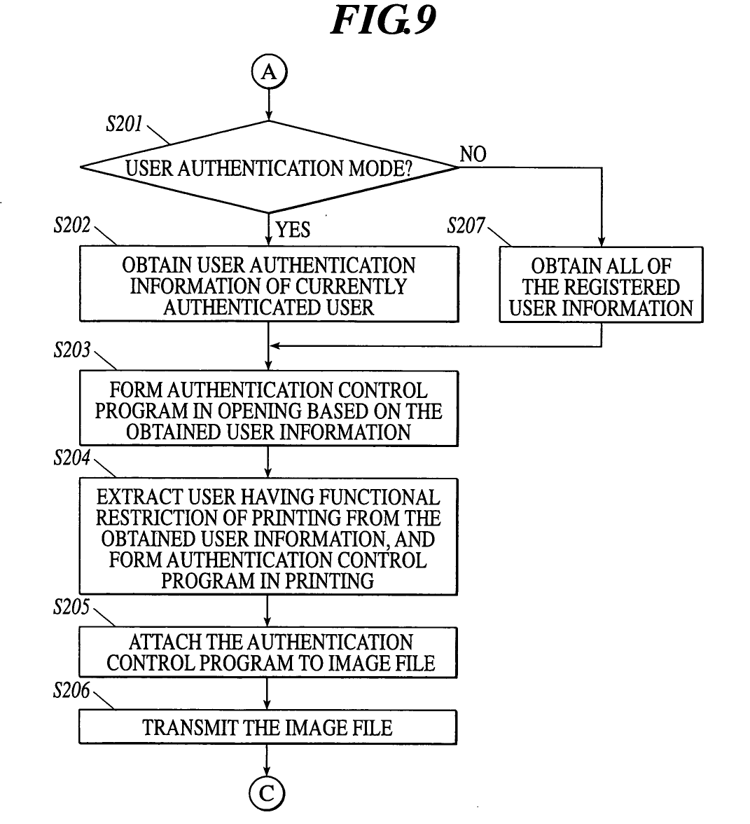

In step S110, the CPU 10 judges whether or not the destination of the image data is the box provided in the storage 13 (see FIG. 7). When the destination is the box, the process shifts to step S111 (step S110: Yes). When the destination is other than the box of the storage 13, i.e. the e-mail server 7, FTP server 8, SMB server 9 or the like, the process shifts to step S201 shown in FIG. 9 (step S110: No). The process of Step S201 or later will be described later.

In step S111, the CPU 10 compares data size of the image data file formed in step S109 with storage capacity of the box of the destination. That is, since storage capacity of each box is limited, it is impossible to store the image data file whose data size excesses the storage capacity of the box.

In step S112, the CPU 10 judges whether or not the data size of the image data is not more than the storage capacity of the box, as a result of the comparison in step S111. When the data size of the image data file excesses the storage capacity of the box, the process shifts to step S301 (step S112: No). When the data size of the image data file is not more than the storage capacity of the box, the process shifts to step S113 (step S112: Yes). Thereafter, the image data file is stored in the designated box and the process ends.

Next, the process in the case where the judgment in step S110 is No, i.e. the destination of the image data file is other than the box is described.

In step S201, the CPU 10 judges whether or not the user authentication mode is in execution in the MFP 1. That is, when the user authentication mode is in execution in the MFP 1, a user who currently uses the MFP 1 can be specified based on the user authentication information read in step S103 (see FIG. 8). However, when the user authentication mode is not in execution, the user cannot be specified. Therefore, the procedure after step S201 branches in order to enable to form the “authentication control program” even when the user authentication mode is in a halt.

When it is judged in step S201 that the user authentication mode is in execution (step S201: Yes), the process shifts to step S202 and the CPU 10 obtains the currently authenticated user authentication information from the authentication information temporary stored in the RAM 12.

On the other hand, when it is judged in S201 that the user authentication mode is not in execution (step S201: No), the process shifts to step S207 and the CPU 10 reads out and obtains all of the user authentication information registered (stored) in the storage 13.

In step S203, the CPU 10 forms the “authentication control program in opening” based on the user authentication information obtained in step S201 or step S207. The “authentication control program in opening” is a program to require input of a user name and user password so as to perform authentication, for example when the image data file is moved to the client PC 5 through the SMB server 9 and then the image data is expanded (opened) on the PC 5. In earlier development, when image data is moved to the other client device on a network, it is impossible to provide a security function with the moved image data. In the present embodiment, such problem is solved.

Further, as described in step S202, this “authentication control program in opening” is formed based on the user authentication information which has already set on the MFP 1. Therefore, it is advantageous that it is not necessary to set user information and user password in the other client equipment on the network and to input and set user name and password repeatedly every time the image data is moved.

Next, in step S204, the CPU 10 detects whether or not printing is prohibited in the items of functional restriction of the user authentication information (in the example shown in FIG. 3, “A” has the item of functional restriction that printing is prohibited). Based on the detection result, the CPU 10 forms the “user authentication program in printing”. The “user authentication program in printing” is a program to require input of user name and user password, for example when the image data file is moved to the client PC 5 through the SMB server 9 and thereafter the PC 5 allows the MFP 1 to print this image data file. That is, it is supposed from the status of functional restriction where printing on the MFP 1 is prohibited, that it is necessary to prevent leakage of information by a printed matter. Thus, it is reasonable that such prevention of the information leakage is also applied to the situation that the moved image data file is printed. As a result, in addition to the security of user authentication, the setting of prohibition set on the MFP 1 can be made effective also to the moved image data file without complicated setting operation.

In step S205, the CPU 10 adds the two “authentication control program” of the “authentication control program in opening” and “authentication control program in printing” formed in step S203 and S204 to the image file.

In step S206, the CPU 10 outputs the image data file to which the “authentication control program” has been added in step S205 to the designated destination such as the SMB server 9. Thereafter, the process ends.

Next, the process in the case where the judgment in step S112 is No, i.e. the destination of the image data file designated by a user is the box but the data size of the image data file excesses the storage capacity thereof, is described. In this case, since the image data file cannot be stored in the box, it is transmitted to and stored in the FTP server 8, SMB server 9 or the like on the network N.

In step S301, the CPU 10 obtains from the RAM 12 the box authentication items of “box name”, “box password” and “access restriction” (see FIG. 4) of the box to which the image data file originally was to be stored.

In step S302, the CPU 10 judges whether or not the box to which the image data file originally was to be stored is a shared box, based on the authentication information obtained in step S301. When it is judged that the box is not a shared box, the process shifts to step S303 (step S302: No). On the other hand, when it is judged that the box is a shared box, the process shifts to step S308 (step S302: Yes).

In step S303, the CPU 10 detects a user name of the user who are permitted to access the box by referring an access permission item of the box authentication information (for example, the access permission item of the box “0001” denotes “A” has an access permission), and obtains the user name, user password and information of functional restriction items corresponding to the detected user.

On the other hand, when the judgment in step S302 is No, the CPU 10 obtains all of the user authentication information registered (recorded) in the storage 13 (see FIG. 3) in step S308. Thereafter, the process shifts to step S304.

In step S304, the CPU 10 forms the “authentication control program in opening” based on the user authentication information obtained in step S303 and step S308.

Then in step S305, the CPU 10 detects whether or not restriction to prohibit printing is set and detects a user to which the restriction to prohibit printing is set, based on the functional restriction items of the user authentication information. The CPU 10 forms the “authentication control program in printing” based on this detection result.

In step S306, the CPU 10 adds two “authentication control program” of the “authentication control program in opening” and “authentication control program in printing” formed in step S304 and step S305 to the image file.

In step S307, the CPU 10 outputs the image data file to which the “authentication control program” has been attached in step S306 to the designated destination such as the SMB server 9. Thereafter, the process ends.

Next, a user authentication process in the client PCs 5 and 6 is described, in which the client PCs 5 and 6 receives the image data file attached with the “authentication control program ” formed in the above-described “authentication program forming process” through the SMB server 9. The “authentication control program” contains all of the user authentication information registered in the MFP 1 or the authentication information related to a specific user, and contains functional user authentication information formed by utilizing the box authentication information and user authentication information. At the time of expanding or printing the image data file, the client PCs 5 and 6 perform an “authentication process in opening” or “authentication process in printing” for judging whether or not the image data file is to be expanded or printed based on this authentication information. The “authentication process in opening” and “authentication process in printing” are described below. Previously, schematic constitution of the client PCs 5 and 6 is described.

FIG. 11 is a block diagram showing schematic constitution of the client PC 5 and the like. The client PC 5 comprises a PC CPU 70 to perform entire control, a PC ROM 71 composed of a non-volatile semiconductor element to store an operation program and various application programs, a PC RAM 72 composed of a volatile semiconductor to function as a work area, a PC storage 73 composed of a non-volatile memory such as a hard disk to store the image data file transmitted from the MFP 1 and various data, a PC operation member 74 as a user interface composed of a keyboard, mouse and the like, a PC external input and output I/F member 75 to control various communication through the network N, and a monitor 76.

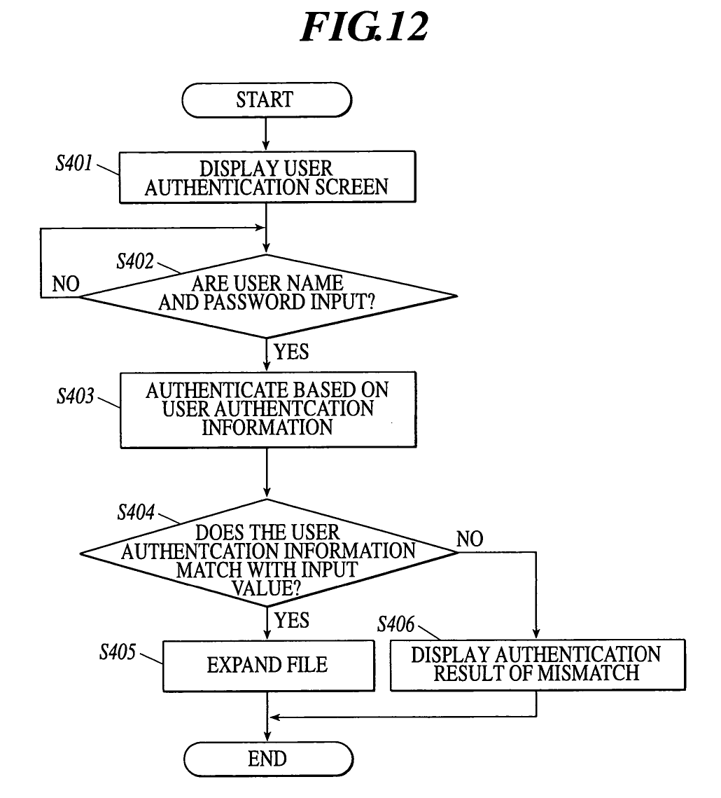

Firstly, regarding the client PC 5 comprising the above constitution, a process performed in cooperation with the “authentication control program in opening” is described with reference to the flowchart shown in FIG. 12. When a user gives an operation to expand the image data file received from the MFP 1, the PC CPU 70 starts reading the “authentication control program in opening” included in the image data file.

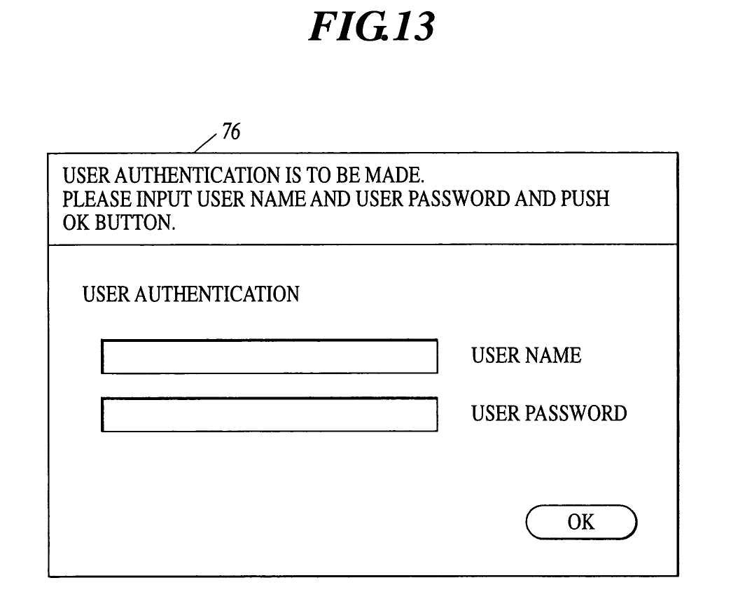

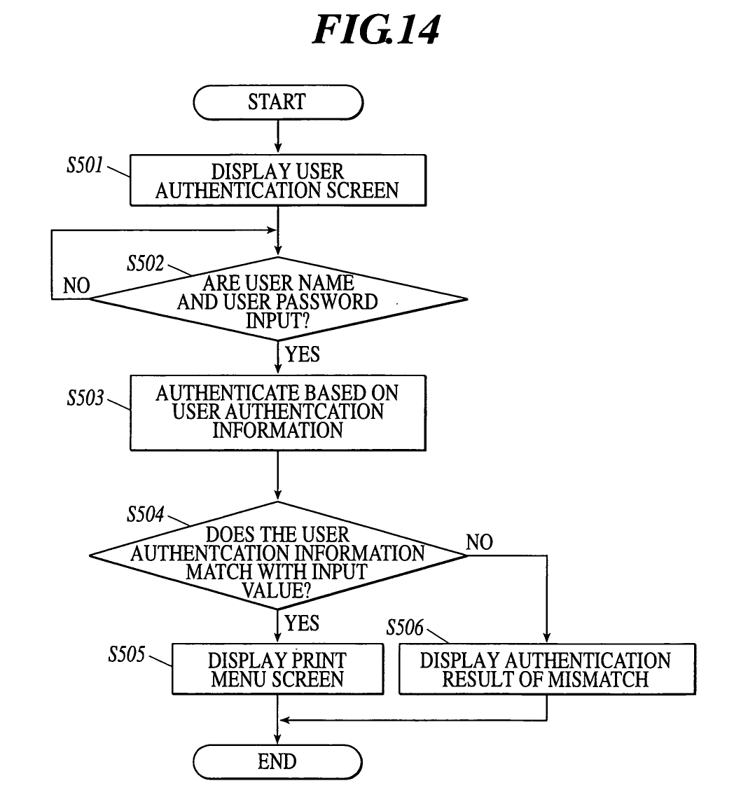

In step S401, the PC CPU 70 displays a user authentication input screen which requires a user name and user password on the monitor 76 (see FIG. 13). The user name and user password to be inputted according to this screen are as same as the user name and user password of the user authentication information (see FIG. 3).

In step S402, the PC CPU 70 is in a halt condition until the user name and user password are input (step S402: No). When the user name and user password are input (step S402: Yes), the process shifts to step S403.

In step S403, the PC CPU 70 refers to the user authentication information included in the “authentication control program in opening”, and compares it with the inputted user name and user password so as to make authentication.

In step S404, when the PC CPU 70 judges as a result of the authentication in step S403 that the inputted user name and user password match with the user authentication information, the process shifts to step S405 (step S404: Yes). On the other hand, when it is judged that the inputted user name and user password do not match with the user authentication information, the process shifts to step S406.

In step S405, the PC CPU 70 expands the image data file and displays an image on the monitor 76 based on the image data.

On the other hand, in step S406, the PC CPU 70 does not expand the image data file but displays that the authentication results mismatch, and the process of the “authentication control program in opening” ends.

Next, a procedure of the “authentication control program in printing” is described with reference to flowchart shown in FIG. 14. When a user makes an operation to print the image data file received from the MFP 1, the PC CPU 70 starts reading the “authentication control program in printing” included in the image data file.

In step S501, the PC CPU 70 displays a user authentication input screen to require a user name and user password on the monitor 76 (see FIG. 13). The user name and user password to be inputted according to the screen are as same as the user name and user password of the user authentication information (see FIG. 3).

In step S502, the PC CPU 70 is in a halt condition until the user name and user password are input (step S502: No). When the user name and user password are input, the process shifts to step S503 (step S502: Yes).

In step S503, the PC CPU 70 refers to the functional user authentication information included in the “authentication control program in printing”, and compares it with the inputted user name and user password so as to make authentication.

In step S504, when the PC CPU 70 judges as a result of the authentication in step S503 that the inputted user name and user password match with the user authentication information, the process shifts to step S505 (step S504: Yes). On the other hand, when it is judged that the input user name and user password do not match with the user authentication information, the process shifts to step S506.

In step S505, the PC CPU 70 displays a print menu screen to accept input of various print setting, and the process of the “authentication control program in printing” ends.

On the other hand, in step S506, the PC CPU 70 does not expand the image data file, but displays that the authentication results mismatch, and the process of the “authentication control program in printing” ends.

According to the MFP 1 to which present invention is applied, the security function of the MFP 1 can be applied to each of the image data, since the “authentication control program” is formed based on the user authentication information and box authentication information which is set in the MFP 1. That is, according to the “authentication control program forming process”, even when the image data are moved from the MFP 1 to the other client device in the network, it can be made to require an input of authentication information in opening or printing the image data file by a function of the “authentication control program” attached to the image data file. Thus, it is possible to ensure security of the image data file. In particular, the MFP 1 of the present embodiment forms the “authentication control program” by utilizing the user authentication information and box authentication information previously set in the MFP 1. Thus, it is advantageous that the security of the image data regarding the storage and management thereof established in the MFP 1 can be applied to the other terminals present on the network without any complicated operation.

Further, since the information source previously stored in the MFP 1 such as the user authentication information is utilized, it saves a trouble that a user inputs the authentication information every time in forming the “authentication control program” attached to the image data file. Thus, the image data can be transmitted easily while ensuring the security in information management.

The embodiment to carry out the invention has been described. The embodiment is disclosed to illustrate an example and thus, the present invention is not limited to the above-described various examples, and can be subject to modification, alternation, addition or the like within a scope of the technical sprit of the invention. For example, in the present embodiment, it is disclosed that the image data file is moved to the client PC 5 through the SMB server 9 as an example. However, the external storage to store the image data file is not limited to an device connected through a network. For example, a memory device detachably connected to the MFP, such as a USB memory, PC card memory or the like, can be given.

What is claimed is:

1. An image data processing apparatus comprising:
an authentication section which authenticates a user who uses at least a part of the image data processing apparatus, based on inputted authentication information and previously set authentication information; and
a controlling section which attaches the previously set authentication information as information to authenticate the user of the image data with an image data to be stored in an external storage.

2. The image data processing apparatus of claim 1, further comprising:
an authentication control program forming section which forms an authentication control program to authenticate a user when the image data is used, based on the previously set authentication information,
wherein the controlling section attaches the authentication control program with the image data.

3. The image data processing apparatus of claim 1, further comprising:
a storage section which stores the image data,
wherein the previously set authentication information is authentication information to use at least a part of the storage section.

4. The image data processing apparatus of claim 3, wherein when data size of the image data is more than storage capacity of the storage section, the authentication information is attached with the image data and the image data is stored in the external storage.

5. The image data processing apparatus of claim 3, wherein the storage section comprises a plurality of data storage units each having predetermined storage capacity, and the image data is stored in one of the data storage units.

6. An image data processing method comprising the steps of:
authenticating a user who uses at least a part of an image data processing apparatus, based on inputted authentication information and previously set authentication information; and
attaching the previously set authentication information as information to authenticate the user of the image data with an image data to be stored in an external storage.

7. The image data processing method of claim 6, further comprising the steps of:
forming an authentication control program to authenticate a user when the image data is used, based on the previously set authentication information,
wherein in the attaching step, the authentication control program is attached with the image data.

8. The image data processing method of claim 6, wherein the image data processing apparatus comprises a storage section which stores the image data, and the previously set authentication information is authentication information to use at least a part of the storage section.

9. The image data processing method of claim 8, further comprising the steps of:
when data size of the image data is more than storage capacity of the storage section, attaching the authentication information to the image data and storing the image data with the external storage.

10. The image data processing method of claim 8, wherein the storage section comprises a plurality of data storage units each having predetermined storage capacity, and the image data is stored in one of the data storage units.

11. A computer-readable recording medium storing program for causing a computer of controlling an image data processing apparatus to carry out the functions of:
authenticating a user who uses at least a part of the image data processing apparatus, based on inputted authentication information and previously set authentication information; and
attaching the previously set authentication information as information to authenticate the user of the image data with an image data stored in an external storage.

12. The computer-readable recording medium of claim 11, further causing the computer to carry out the function of:
forming an authentication control program to authenticate a user when the image data is used, based on the previously set authentication information,
wherein in the attaching step, the authentication control program is attached with the image data.

13. The computer-readable recording medium of claim 11, wherein the image data processing apparatus comprises a storage section which stores the image data, and the previously set authentication information is authentication information to use at least a part of the storage section.

14. The computer-readable recording medium of claim 13, further causing the computer to carry out the function of:
when data size of the image data is more than storage capacity of the storage section, attaching the authentication information to the image data and storing the image data with the external storage.

15. The computer-readable recording medium of claim 13, wherein the storage section comprises a plurality of data storage units each having predetermined storage capacity, and the image data is stored in one of the data storage units.
